(19) United States
(12) Patent Application Publication
(10) Pub. No.: US 2010/0231542 A1
(43) Pub. Date: Sep. 16, 2010

(54) TOUCH PANEL DEVICE, ELECTRO-OPTICAL DEVICE, AND ELECTRONIC APPARATUS

(75) Inventor: Seigo MOMOSE, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/716,317

(22) Filed: Mar. 3, 2010

(30) Foreign Application Priority Data
Mar. 11, 2009 (JP) 2009-058784

(51) Int. Cl. G06F 3/041

(52) U.S. Cl. 345/173

(57) ABSTRACT

A touch panel device includes: a touch panel substrate; a plurality of surface-shaped electrodes which are provided on one surface side of the touch panel substrate and are separated from each other; a first wiring line which makes a connection between the surface-shaped electrodes adjacent to each other in a first direction of the touch panel substrate; a second wiring line which makes a connection between the surface-shaped electrodes adjacent to each other in a second direction different from the first direction and which is formed integrally with the surface-shaped electrodes; and an insulating layer which insulates the first and second wiring lines from each other and is formed by a liquid-phase deposition method, wherein the first wiring line, the insulating layer, and the second wiring line are disposed on the one surface of the touch panel substrate so as to overlap each other in this order.

### BACKGROUND

1. Technical Field

The invention relates to a touch panel device, an electro-optical device, and an electronic apparatus.

2. Related Art

In recent years, touch panel devices have come into wide use as input devices for operating electronic apparatuses, such as an automatic teller machine (ATM). Such touch panel devices are mounted on the display surface sides of various display devices, such as liquid crystal display devices, and perform various kinds of operation, input, and the like of electronic apparatuses by specifying the contact position when the arbitrary position on a touch surface is touched by an input device such as a touch pen, a finger of a human being, or the like according to the display contents of the display devices viewed through the touch panel devices. Various types of devices, such as a resistive film type device, a capacitance coupling type device, and a surface acoustic wave type device, are known as the touch panel devices.

JP-A-9-305289 discloses a capacitive coordinate input device including: a sensor substrate having a plurality of first electrodes, which is provided on a top surface of a film body and extends in parallel to each other, and a plurality of second electrodes which is provided on a bottom surface of the film body, extends in a direction perpendicular to the first electrode group, and is parallel to each other; a filling layer which is provided in a region of the top surface of the film body where the first electrode group is not present and which has the same thickness as the first electrode group; and a protection sheet bonded to top surfaces of the filling layer and first electrode group. This coordinate input device is configured such that the current value according to a change in capacitance between the first and second electrode groups is measured and output when a user touches a surface of the protection sheet with a finger and the coordinate position pressed by the finger can be detected on the basis of the current output value.

FIG. 7 is a cross-sectional view showing the schematic configuration of a known capacitive touch panel device. In addition, in the following explanation, it is assumed that the upper side in FIG. 7 is “upper” and the lower side is “lower”.

A touch panel device 900 shown in FIG. 7 includes a substrate 910, a Y electrode 920 formed on a lower surface of the substrate 910, an X electrode 930 formed on an upper surface of the substrate 910, a protection sheet 950 provided above the substrate 910 with the X electrode 930 interposed therebetween, and an adhesion layer 940 which is filled between the substrate 910 and the protection sheet 950 in order to bond the substrate 910 and the protection sheet 950 to each other. The upper surface of the protection sheet 950 is a touch surface of the touch panel device 900. When the touch surface is touched by a finger or the like, the touch panel device 900 detects the touch position.

Here, the Y and X electrodes 920 and 930 are a plurality of linear electrodes extending in directions perpendicular to each other, and a capacitance is formed between the electrodes 920 and 930. Since the capacitance changes before and after the touch surface is touched by a finger or the like, the touch panel device 900 specifies the touch position by detecting the change in capacitance in each of the electrodes 920 and 930.

In such a touch panel device 900, however, the Y and X electrodes 920 and 930 are provided on different surfaces of the substrate 910. This makes the manufacturing process complicated. Particularly, the Y and X electrodes 920 and 930 are formed through the complicated process in which conductive films are formed and are then patterned into desired shapes by a photolithography method and an etching method. This increases the total manufacturing cost of the touch panel device 900.

In addition, since the electrodes are provided on both surfaces of the substrate 910, it has been difficult to make the touch panel device 900 thin.

In addition, although not shown in FIG. 7, a protection sheet which protects the Y electrodes 920 is also needed. In this case, since it is not possible to avoid an increase in the number of layers which form the touch panel device 900, there is also a problem that the optical transparency deteriorates.

### SUMMARY

An advantage of some aspects of the invention is that it provides a capacitive touch panel device, which is thin and has high optical transparency and which can be easily manufactured and is highly reliable, and an electro-optical device and an electronic apparatus which have the touch panel device and have high performance.

In addition, another advantage of some aspects of the invention is that it provides a touch panel device having an insulating layer excellent in insulation performance since the profile shape is a target shape, even if the insulating layer is formed by a liquid-phase deposition method, by preventing the insulating layer formed by the liquid-phase deposition method from being broken according to the surface state of a base.

According to an aspect of the invention, there is provided a touch panel device including: a touch panel substrate; a plurality of surface-shaped electrodes which are provided on one surface side of the touch panel substrate and are separated from each other; a first wiring line which makes a connection between the surface-shaped electrodes adjacent to each other in a first direction of the touch panel substrate; a second wiring line which makes a connection between the surface-shaped electrodes adjacent to each other in a second direction different from the first direction and which is formed integrally with the surface-shaped electrodes; and an insulating layer which insulates the first and second wiring lines from each other and is formed by a liquid-phase deposition method. The first wiring line, the insulating layer, and the second wiring line are disposed on the one surface of the touch panel substrate so as to overlap each other in this order.

In this case, it is possible to obtain a capacitive touch panel device which is thin and has high optical transparency and which can be easily manufactured and is highly reliable.

In the touch panel device according to the aspect of the invention, it is preferable that the thickness of an edge portion of the insulating layer decreases gradually toward an outer edge.

In this case, the edge portion of the insulating layer has a gentle slope. Accordingly, when the surface-shaped electrode and the second wiring line are laminated on the insulating layer, it is possible to prevent the surface-shaped electrode or the second wiring line from being cut into pieces in the edge portion of the insulating layer.

In the touch panel device according to the aspect of the invention, it is preferable that the first wiring line is formed by the liquid-phase deposition method.

In this case, the plurality of first wiring lines each of which has a small area can be formed efficiently. In addition, the consumption of a raw material can be reduced compared with a method of forming a conductive layer on the entire upper surface of the touch panel substrate and then removing the conductive layer in the unnecessary region.

In the touch panel device according to the aspect of the invention, it is preferable that the thickness of an edge portion of the first wiring line decreases gradually toward an outer edge.

In this case, the edge portion of the first wiring line has a gentle slope. Accordingly, when the insulating layer, the surface-shaped electrode, and the second wiring line are laminated on the first wiring line, it is possible to prevent the insulating layer, the surface-shaped electrode, and the second wiring line from being cut into pieces in the edge portion of the first wiring line.

In the touch panel device according to the aspect of the invention, it is preferable that at least one of the insulating layer and the first wiring line is formed by an ink jet method.

In this case, partial film formation is possible even if a mask is not prepared which covers a region where a layer is not formed.

In the touch panel device according to the aspect of the invention, it is preferable that the plurality of surface-shaped electrodes and the second wiring line are formed by a gas-phase deposition method.

In this case, when forming the surface-shaped electrodes and the second wiring line so as to cover the edge portion of the first wiring line and the edge portion of the insulating layer, it is difficult for a problem that the layer becomes partially thin or cracks to occur. Accordingly, it is possible to obtain a uniform layer reliably.

In the touch panel device according to the aspect of the invention, it is preferable that at least middle portions of the plurality of surface-shaped electrodes are located on the same plane.

In this case, since the distance between the touch surface of the touch panel device and each surface-shaped electrode becomes approximately constant, a variation in capacitance occurring between the user's finger and each surface-shaped electrode is suppressed. Accordingly, when detecting the touch position on the basis of a change in capacitance, the detection accuracy can be improved.

In the touch panel device according to the aspect of the invention, it is preferable that the average thickness of the insulating layer is 0.5 to 3 μm.

In this case, the insulating layer can ensure the insulating property while maintaining sufficient optical transparency.

According to another aspect of the invention, there is provided an electro-optical device including: an electro-optical element; and the above-described touch panel device which is disposed on one surface side of the electro-optical element.

In this case, it is possible to obtain a high-performance electro-optical device including the touch panel device.

According to yet another aspect of the invention, there is provided an electronic apparatus including the electro-optical device described above.

In this case, a high-performance electronic apparatus is obtained.

### BRIEF DESCRIPTION OF THE DRAWINGS

The invention will be described with reference to the accompanying drawings, wherein like numbers reference like elements.

FIG. 1 is a block diagram showing a touch panel device according to an embodiment of the invention.

FIG. 2 is a plan view showing the schematic configuration of a touch sensor provided in the touch panel device shown in FIG. 1.

FIG. 3 is a cross-sectional view taken along the line A-A of the touch sensor shown in FIG. 2.

FIGS. 4A to 4E are views illustrating a method of manufacturing the touch sensor shown in FIG. 3.

FIG. 5 is a longitudinal sectional view showing an electro-optical device according to another embodiment of the invention.

FIG. 6 is a perspective view showing the configuration of a mobile phone (PHS is also included) to which an electronic apparatus according to another embodiment of the invention is applied.

FIG. 7 is a cross-sectional view showing the schematic configuration of a known capacitive touch panel device.

### DESCRIPTION OF EXEMPLARY EMBODIMENTS

Hereinafter, a touch panel device, an electro-optical device, and an electronic apparatus according to preferred embodiments of the invention will be described with reference to the accompanying drawings.

### Touch Panel Device

First, a touch panel device according to an embodiment of the invention will be described.

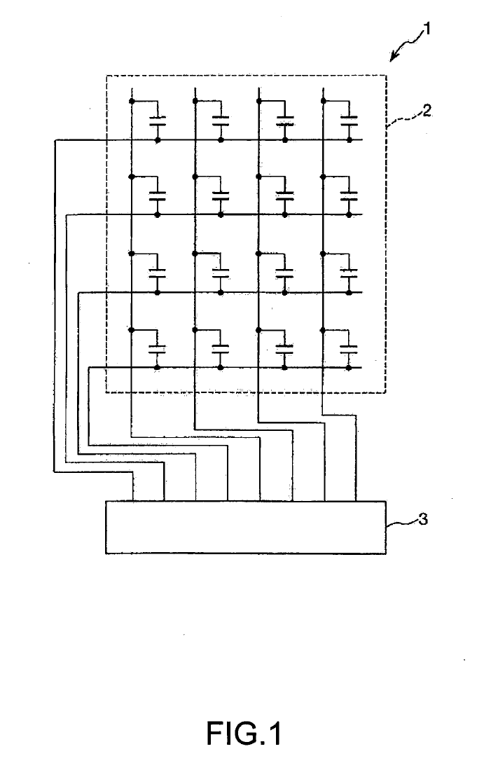

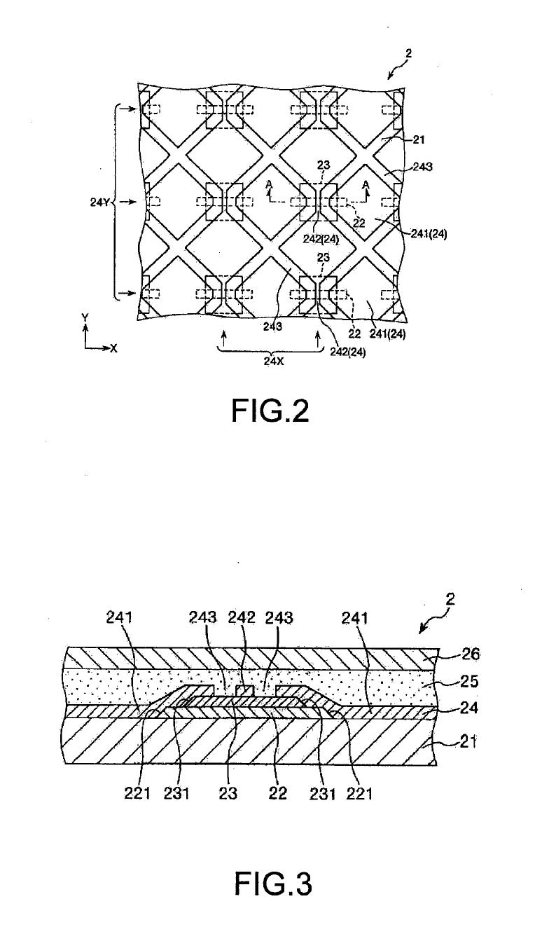

FIG. 1 is a block diagram showing the touch panel device according to the embodiment of the invention, FIG. 2 is a plan view showing the schematic configuration of a touch sensor provided in the touch panel device shown in FIG. 1, and FIG. 3 is a cross-sectional view taken along the line A-A of the touch sensor shown in FIG. 2. In addition, in the following explanation, it is assumed that the upper side in FIG. 3 is “upper”, the lower side is “lower”, the right side is “right”, and the left side is “left”. Moreover, in FIG. 2, an XY plane is set and a state is shown in which a protection sheet and an adhesive layer are omitted.

A touch panel device 1 shown in FIG. 1 includes a touch sensor 2 and a control circuit 3 electrically connected to the touch sensor 2.

Such a touch panel device 1 is placed on various kinds of display devices, such as a liquid crystal display device or an organic EL display device, and functions as an input device which allows the display contents of the display device to be transmitted therethrough and which performs various kinds of input operations on the display device.

Hereinafter, the configuration of each section will be described in detail.

As shown in FIGS. 2 and 3, the touch sensor 2 has a touch panel substrate 21, a lower wiring line (first wiring line) 22 provided on the touch panel substrate 21, an insulating layer 23 which is provided on the lower wiring line 22 such that a part of the lower wiring line 22 protrudes to the outside of the insulating layer 23, an electrode pattern 24 which is provided on the touch panel substrate 21 so as to cover a part of the lower wiring line 22 and the insulating layer 23, and a protection sheet 26 placed thereabove with an adhesive layer 25 interposed therebetween.

As the touch panel substrate 21, a substrate which has optical transparency and insulating property is used. For example, substrates formed of various kinds of glass materials, such as soda glass, alkali-free glass, borosilicate glass, and quartz glass, and substrates formed of various kinds of resin materials, such as polyimide based resin, acrylic based resin, polyester based resin, and polycarbonate based resin, may be mentioned.

As shown in FIG. 2, the electrode pattern 24 has a plurality of surface-shaped electrodes 241, which are regularly arrayed on the touch panel substrate 21 and have rhombic shapes, and a plurality of linear upper wiring lines (second wiring lines) 242, which connect the surface-shaped electrodes 241 adjacent to each other in the Y-axis direction among the surface-shaped electrodes 241. In addition, in a region other than the region where the upper wiring lines 242 are provided, the surface-shaped electrodes 241 are separated from each other with a gap 243 interposed therebetween.

On the other hand, the lower wiring line 22 is provided such that both ends thereof protrude from the left and right sides of the insulating layer 23, as shown in FIGS. 2 and 3. Accordingly, the lower wiring line 22 connects the surface-shaped electrodes 241, which are adjacent to each other in the X-axis direction, among the surface-shaped electrodes 241 with the gap 243 interposed therebetween.

As a result, the electrode pattern 24 has a plurality of current paths (extending along the X axis) arrayed in parallel in the Y-axis direction and a plurality of current paths (extending along the Y axis) arrayed in parallel in the X-axis direction. Here, it is assumed that the former current path is a Y electrode 24Y shown in FIG. 2, and the latter current path is an X electrode 24X shown in FIG. 2.

Each of the electrode pattern 24 and the lower wiring line 22 is formed of a conductive material of a transparent conductive film, such as an indium oxide, a tin oxide, a zinc oxide, and a compound (ITO) of an indium oxide and a tin oxide, and has optical transparency.

In addition, each insulating layer 23 shown in FIG. 2 has a square shape in plan view and is provided in a region, in which the four surface-shaped electrodes 241 are adjacent to each other, so as to be covered by the four surface-shaped electrodes 241. Each insulating layer 23 is provided between each upper wiring line 242 and each lower wiring line 22 so that each upper wiring line 242 and each lower wiring line 22 can be insulated from each other.

Such an insulating layer 23 is formed of various kinds of resin materials, such as an epoxy resin, a urethane resin, a urea resin, an acrylic resin, a polyvinyl alcohol resin, a melamine resin, a polyamide resin, a polyamidoimide resin, a polyimide resin, a tetrafluoroethylene resin, and a silicon resin (polysiloxane), various kinds of oxide based materials, such as a silicon oxide, and the like and has optical transparency.

In addition, it is preferable that the average thickness of each insulating layer 23 is about 0.5 to 3 μm. More preferably, the average thickness of each insulating layer 23 is about 1 to 2 μm. The insulating layer 23 with such a thickness can ensure the necessary insulating property while maintaining sufficient optical transparency.

In addition, it is preferable that the relative permittivity of each insulating layer 23 is 4 or less. More preferably, the relative permittivity of each insulating layer 23 is 3.5 or less.

In this case, the capacitance occurring in the insulating layer 23 is optimized. In addition, it is preferable that the refractive index of each insulating layer 23 is 2 or less. More preferably, the refractive index of each insulating layer 23 is 1.7 or less. The refractive index of the insulating layer 23 is relatively close to those of the touch panel substrate 21, lower wiring line 22, and electrode pattern 24. Accordingly, it is possible to improve the optical transparency of the entire touch panel device 1.

In addition, the adhesive layer 25 serves to bond the touch panel substrate 21, which includes the electrode pattern 24, the insulating layer 23, and the lower wiring line 22, to the protection sheet 26. For example, a urethane based adhesive, an epoxy based adhesive, and a silicon based adhesive may be mentioned.

In addition, sheet materials, such as an epoxy resin, a polyimide resin, a silicon resin, an acrylic resin, a urethane resin, a urea resin, a polyester resin, and a polyolefin resin, may be mentioned as the protection sheet 26.

The upper surface of the protection sheet 26 serves as a touch surface touched by the user of the touch panel device 1.

Here, a capacitance shown in FIG. 1 is formed between portions of the touch sensor 2.

Moreover, the control circuit 3 connected to the touch sensor 2 selects one of the plurality of Y electrodes 24Y or selects some of the plurality of Y electrodes 24Y sequentially for a certain period of time and applies a voltage to the selected Y electrode 24Y. In this case, the Y electrodes 24Y which are not selected are separated from the voltage applying circuit. By this voltage application, the voltage of the X electrode 24X is measured.

On the other hand, for a different period of time, the control circuit 3 selects one of the plurality of X electrodes 24X or selects some of the plurality of X electrodes 24X sequentially and applies a voltage to the selected X electrode 24X. In this case, the X electrodes 24X which are not selected are separated from the voltage applying circuit. By this voltage application, the voltage of the Y electrode 24Y is measured.

In this way, the control circuit 3 controls input/output signals of the Y and X electrodes 24Y and 24X in a time-division manner to measure the voltage of the Y or X electrode 24Y or 24X.

Here, the measured voltage is generated on the basis of a change in capacitance between the Y and X electrodes 24Y and 24X.

The change in capacitance occurs when the user of the touch panel device 1 touches the touch surface. This is because a capacitor is formed between the user's finger and the Y electrode 24Y or the X electrode 24X with the touching of the touch surface, and accordingly, the capacitance between the Y and X electrodes 24Y and 24X changes.

Therefore, the touch panel device 1 can detect the touch position on the touch surface on the basis of the voltage value measured at the Y electrode 24Y or the X electrode 24X.

The touch panel device 1 functions as an input device by inputting the touch position, which was detected as described above, to an operational circuit (for example, a CPU) which controls the display contents of various display devices from the control circuit 3.

Moreover, in such a touch panel device 1, each surface-shaped electrode 241 occupies a relatively large area.

Such a surface-shaped electrode was provided on both surfaces of a substrate in the related art. For this reason, since it was necessary to perform the process of forming the surface-shaped electrodes at least twice, the manufacturing process was complicated.

In addition, providing the surface-shaped electrodes on both surfaces of the substrate was also disadvantageous from a point of view of making the touch panel device thin.

Moreover, when the surface-shaped electrodes are provided on both surfaces of the substrate, it is necessary to provide protection sheets for protecting the surface-shaped electrodes on both the surfaces. For this reason, it was difficult to make the touch panel device thin, and the optical transparency of the touch panel device dropped.

On the other hand, in the touch panel device 1, the surface-shaped electrodes 241 are formed on the same surface side of the touch panel substrate 21. Accordingly, since the surface-shaped electrodes 241 can be formed by performing the process once, the manufacturing cost of the touch panel device 1 can be reduced.

In addition, by providing the surface-shaped electrodes 241 on only one surface of the touch panel substrate 21, it is possible to make the touch panel device 1 thin and it is also possible to improve the optical transparency since the number of layers needed for the touch panel device 1 can be reduced.

In addition, at least middle portions of the plurality of surface-shaped electrodes 241 are located on the same plane, that is, equally distant from the touch panel substrate 21. In this case, since the distance between the touch surface and each surface-shaped electrode 241 also becomes approximately constant, a variation in capacitance occurring between the user's finger and each surface-shaped electrode 241 is suppressed. Accordingly, when detecting the touch position on the basis of a change in capacitance, the detection accuracy can be improved.

Next, a method of manufacturing the touch sensor 2 of the touch panel device 1 will be described.

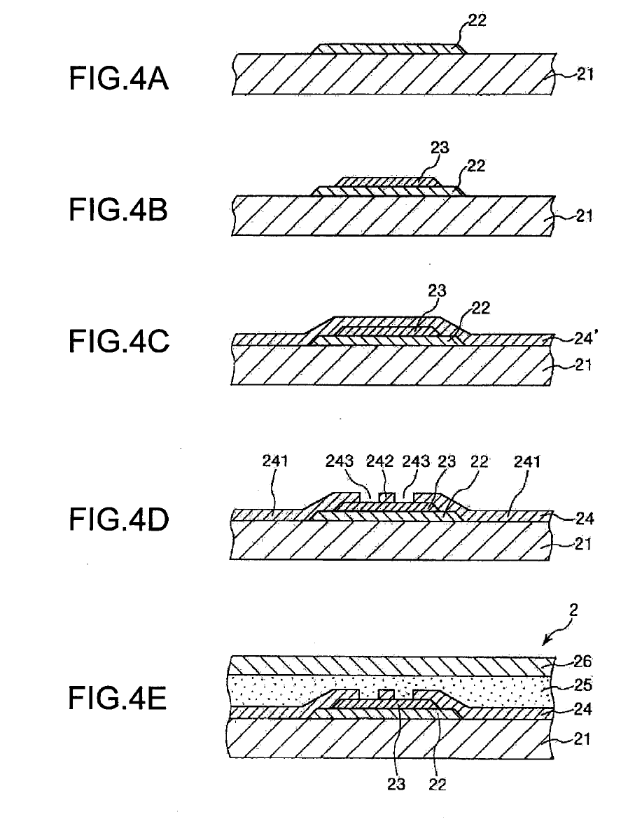

FIGS. 4A to 4E are views illustrating the method of manufacturing the touch sensor shown in FIG. 3.

First, the touch panel substrate 21 is prepared. On the upper surface of the touch panel substrate 21, surface treatment for improving the affinity with the lower wiring line 22 or the insulating layer 23 may be performed as necessary.

Then, as shown in FIG. 4A, the strip-shaped lower wiring lines 22 arrayed with equal distances therebetween are formed on the upper surface of the touch panel substrate 21.

The lower wiring lines 22 may be formed by gas-phase deposition methods, such as a vacuum deposition method, a sputtering method, and a CVD method, and may also be formed by performing film formation of a liquid material containing a raw material of the lower wiring line 22 by liquid-phase deposition methods, such as a screen printing method, an ink jet method, and a sol-gel process.

Among these methods, it is especially preferable to use the liquid-phase deposition method for film formation of the lower wiring line 22, and it is more preferable to use the ink jet method. According to such a deposition method, the plurality of lower wiring lines 22 each of which has a small area can be formed efficiently. In addition, the consumption of a raw material can be reduced compared with a method of forming a conductive layer on the entire surface and then removing the conductive layer in the unnecessary region.

Although a liquid material containing a raw material of the lower wiring line 22 is not particularly limited, dispersion liquid containing particles of a transparent conductive layer, a solution of an organic compound which contains organic tin and organic indium and which can form a transparent conductive layer by reaction, and the like may be mentioned.

After film formation of the liquid material, the obtained liquid coat layer is dried.

Methods, such as heating, decompression, and gas spray, may be mentioned as a method of drying the liquid coat layer.

Then, the dried liquid coat is baked to thereby obtain the lower wiring line 22 formed by a transparent conductive layer.

It is preferable that the baking temperature of the liquid coat is about 150 to 450° C., even though it is not particularly limited.

Then, as shown in FIG. 4B, the insulating layer 23 is formed on the lower wiring line 22. As shown in FIG. 2, the insulating layer 23 is formed such that upper and lower ends thereof protrude from the lower wiring line 22 and left and right ends of the lower wiring line 22 are not covered by the insulating layer 23.

In the invention, the insulating layer 23 is formed by the liquid-phase deposition method. Preferably, the insulating layer 23 is formed by the ink jet method. According to the liquid-phase deposition method, the insulating layer 23 can be efficiently formed with a simple facility.

In addition, when the lower wiring line 22 is formed by the liquid-phase deposition method, it is common that the upper surface of the touch panel substrate 21 is optimized for film formation of the lower wiring line 22. Accordingly, the upper surface of the touch panel substrate 21 also has a satisfactory surface state for the film formation of the insulating layer 23 formed by the liquid-phase deposition method. In addition, the surface of the lower wiring line 22 formed by the liquid-phase deposition method also has high affinity to the liquid material for forming the insulating layer 23. For this reason, the insulating layer 23 shows more excellent adhesion to the touch panel substrate 21 and the lower wiring line 22.

In addition, when the lower wiring line 22 and the insulating layer 23 are formed by the liquid-phase deposition method, the sectional shape of an edge portion 221 of the lower wiring line 22 and the sectional shape of an edge portion 231 of the insulating layer 23 do not have steep level difference but have gentle slopes. In other words, the thickness of the edge portion 221 of the lower wiring line 22 and the thickness of the edge portion 231 of the insulating layer 23 decrease gradually toward the outer edge. Accordingly, when the insulating layer 23 is formed on the lower wiring line 22 with such a shape, the insulating layer 23 is laminated along the edge portion 221 with a gentle slope. As a result, it is possible to prevent the insulating layer 23 from being cut into pieces in the edge portion 221.

Similarly, also when the electrode pattern 24 is formed to cover the lower wiring line 22 and the insulating layer 23, the electrode pattern 24 is laminated along the gentle slope. Accordingly, it is possible to prevent the electrode pattern 24 from being cut into pieces in the edge portion 221 of the lower wiring line 22 or the edge portion 231 of the insulating layer 23.

Moreover, particularly when forming the lower wiring line 22 or the insulating layer 23 by the ink jet method, partial film formation is possible even if a mask is not prepared which covers a region where a layer is not formed. Accordingly, it is necessary to use a liquid material which is high in efficiency of film formation but has high fluidity compared with other coating methods and printing methods. For this reason, for example, when such a liquid material is formed on the lower wiring line 22, a possibility that the liquid coat will flow to drop in the edge portion 221 and be finally cut into pieces is increased. From this point of view, when forming the insulating layer 23 by the ink jet method, it is especially important that the thickness of the edge portion 221 of the lower wiring line 22 decreases gradually toward the outer edge.

Subsequently, the electrode pattern 24 is formed to cover the touch panel substrate 21, the lower wiring line 22, and the insulating layer 23.

Although the electrode pattern 24 may also be formed by the various film forming methods described above, it is especially preferable to use the gas-phase deposition method, and it is more preferable to use the sputtering method. In this case, the electrode pattern 24 can be formed efficiently in a wide region.

In the case where the electrode pattern 24 is formed by the gas-phase deposition method, a conductive layer 24′ as a raw material is first formed on the entire film forming region, as shown in FIG. 4C.

Then, as shown in FIG. 4D, the conductive layer 24′ is patterned into a predetermined shape using a photolithography method and an etching method. Thus, the gap 243 described above is formed, and each surface-shaped electrode 241 and each upper wiring line 242 are formed.

In the case of forming such a conductive layer by the liquid-phase deposition method, it is necessary to form the conductive layer with a level difference of the thickness corresponding to two layers of the lower wiring line 22 and the insulating layer 23. Accordingly, a problem, such as breaking of the conductive layer in the middle, may occur. On the other hand, according to the gas-phase deposition method, even in the case where the electrode pattern 24 is formed to cover the edge portion 221 of the lower wiring line 22 and the edge portion 231 of the insulating layer 23 as shown in FIG. 3, a problem that the layer becomes partially thin or cracks is difficult to occur. Accordingly, it is possible to obtain the uniform conductive layer 24′ reliably.

By applying the adhesive layer 25 on the electrode pattern 24 and placing the protection sheet 26 on the adhesive layer 25 after forming the electrode pattern 24 as described above, the touch panel device 1 shown in FIG. 4E is obtained.

In such a touch panel device 1, the lower wiring line 22, the insulating layer 23, and the electrode pattern 24 are laminated in this order from a side of the touch panel substrate 21.

On the other hand, if the lamination sequence of the lower wiring line 22, the insulating layer 23, and the electrode pattern 24 in the touch panel device 1 is set reversely, the following problems occur.

First, although it is necessary to form the insulating layer 23 on the electrode pattern 24, the surface states of the upper surfaces of each surface-shaped electrode 241 and each upper wiring line 242 and the upper surface of the touch panel substrate 21 exposed to the gap 243 are different. For this reason, even if the insulating layer 23 is formed over the surfaces by the liquid-phase deposition method, there is a possibility that the profile shape of the liquid coat will deform due to repelling of the liquid material and the like.

On the other hand, in the case of the lamination sequence of the touch panel device 1 described above, such a problem can be solved since the touch panel substrate 21 or the lower wiring line 22 has high affinity to the liquid material of the insulating layer 23 as described above. In addition, it can be said that an influence of the lower wiring line 22 on the formation of the insulating layer 23 is small because the shape of the lower wiring line 22 is a strip shape and its area is also small. Thus, according to the embodiment of the invention, the insulating layer 23 with a target shape can be reliably formed.

In addition, in the case where the electrode pattern is formed by the gas-phase deposition method, the photolithography method, and the etching method, the sectional shape of the edge portion of the electrode pattern 24 has a steep level difference in many cases. For this reason, when the insulating layer 23 is formed on the electrode pattern 24 with such a shape, there is a possibility that the insulating layer 23 will be cut into pieces at the level difference of the edge portion of the electrode pattern 24.

On the other hand, according to the lamination sequence of the touch panel device 1 described above, such a problem can be solved since the insulating layer 23 is formed on the lower wiring line 22. As a result, the highly reliable touch panel device 1 is obtained.

### Electro-Optical Device

Next, an electro-optical device in which the touch panel device according to the embodiment of the invention is mounted on an electro-optical element will be described using a case where the electro-optical element is a liquid crystal display device as an example.

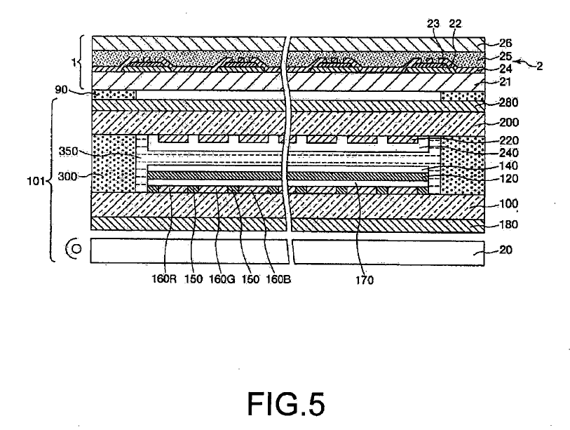

FIG. 5 is a longitudinal sectional view showing an electro-optical device according to another embodiment of the invention. In addition, in the following explanation, it is assumed that the upper side in FIG. 5 is “upper” and the lower side is “lower”.

The electro-optical device 10 has a liquid crystal display device 101 and the touch panel device 1 shown in FIG. 1.

In the liquid crystal display device 101, a pair of lower substrate 100 and upper substrate 200 which are formed of a transparent material, such as glass, are disposed opposite each other. A spacer (not shown) is disposed between the lower substrate 100 and the upper substrate 200, and the distance between the lower substrate 100 and the upper substrate 200 is maintained at about 5 μm, for example. In addition, peripheral portions of the lower substrate 100 and the upper substrate 200 are sealed by a sealing member 300 formed of a thermosetting adhesive, an ultraviolet curable adhesive, or the like.

In addition, a liquid crystal material, such as STN (Super Twisted Nematic) liquid crystal, is enclosed in a space surrounded by the lower substrate 100, the upper substrate 200, and the sealing member 300.

A common electrode 120 made of a transparent conductive material, such as ITO, is formed in a strip shape on the inner surface of the lower substrate 100. In addition, a segment electrode 220 made of a transparent conductive material, such as ITO, is formed in a strip shape on the inner surface of the upper substrate 200. In addition, the segment electrode 220 and the common electrode 120 are disposed so as to be perpendicular to each other, and the vicinity of an intersection between the segment electrode 220 and the common electrode 120 is a display pixel of the liquid crystal display device 101.

In addition, an incidence-side polarizer 180 is disposed on the outer side of the lower substrate 100, and an emission-side polarizer 280 is disposed on the outer side of the upper substrate 200. In addition, the incidence-side polarizer 180 and the emission-side polarizer 280 are disposed such that transmission axes thereof cross each other at a predetermined angle (for example, about 90°). In addition, a backlight 20 is disposed on the outer side of the incidence-side polarizer 180.

As shown in FIG. 5, on the inner surface of the lower substrate 100, coloring material layers 160R, 160G, and 160B of red (R), green (G), and blue (B) which form a color filter are formed corresponding to a plurality of pixels 40. In addition, a light shielding layer 150 is formed between the coloring material layers 160R, 160G, and 160B so that the light leakage from the adjacent pixel 40 is prevented. In addition, a planarizing layer (protective layer) 170 is formed on the surfaces of the coloring material layers 160R, 160G, and 160B and the light shielding layer 150, and the common electrode 120 is formed on the surface of the planarizing layer 170. An alignment layer 140, which regulates the orientation state of liquid crystal when no electric field is applied, is formed on the surface of the common electrode 120.

Moreover, the segment electrode 220 is formed on the inner surface of the upper substrate 200. An alignment layer 240, which regulates the orientation state of liquid crystal when no electric field is applied, is formed on the surface of the segment electrode 220. In addition, the alignment layers 140 and 240 are formed such that the orientation direction of liquid crystal using the alignment layer 240 of the upper substrate 200 and the orientation direction of liquid crystal using the alignment layer 140 of the lower substrate 100 cross each other at a predetermined angle (for example, about 90°).

Moreover, when light from the backlight 20 is incident on the incidence-side polarizer 180, only linearly polarized light along the transmission axis of the incidence-side polarizer 180 is transmitted through the incidence-side polarizer 180. The linearly polarized light transmitted through the incidence-side polarizer 180 rotates, according to the orientation state of liquid crystal when no electric field is applied, while being transmitted through the liquid crystal layer 350 interposed between the substrates 100 and 200. Among the linearly polarized light which has been transmitted through the liquid crystal layer 350, only a linearly polarized light component which matches the transmission axis of the emission-side polarizer 280 is transmitted through the emission-side polarizer 280.

In addition, if a data signal is supplied to one of the common electrode 120 and the segment electrode 220 and a scanning signal is supplied to the other electrode, a voltage is applied to the liquid crystal layer 350 disposed at the pixel 40 of the intersection between both the electrodes 120 and 220. The orientation state of a liquid crystal molecule changes according to the voltage level, and the rotation angle of the linearly polarized light incident on the liquid crystal layer 350 is adjusted. Accordingly, the optical transmittance is controlled for every pixel 40 of the liquid crystal display device 101, such that image display is performed.

Moreover, in the electro-optical device 10, the touch panel device 1 shown in FIG. 1 is mounted on the liquid crystal display device 101 configured as described above.

The touch panel device 1 is electrically connected to the liquid crystal display device 101 such that the lower surface of the touch panel substrate 21 provided in the touch sensor 2 is bonded to the upper surface of the emission-side polarizer 280 of the liquid crystal display device 101 with an adhesive 90 interposed therebetween and the driving of the liquid crystal display device 101 is controlled on the basis of the data of the detected touch input position. Accordingly, an input operation can be performed through the touch panel device 1 and the display of the liquid crystal display device 101 can be changed on the basis of the information on the input operation. As a result, the electro-optical device 10 serves as a display device which can be intuitively operated.

### Electronic Apparatus

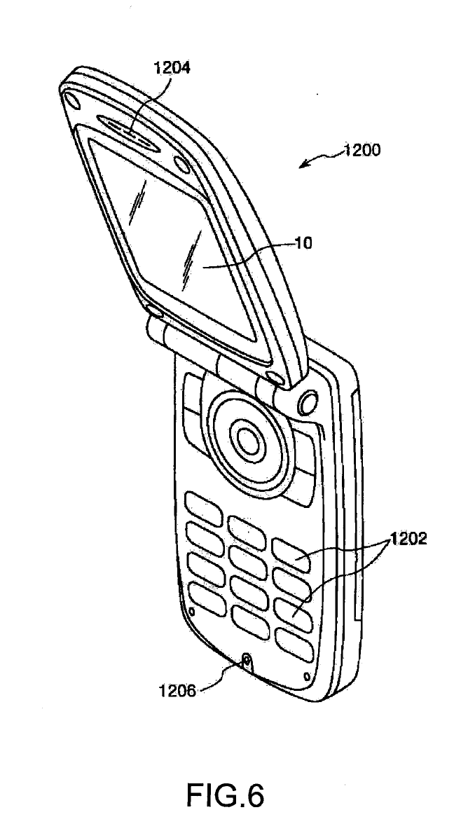

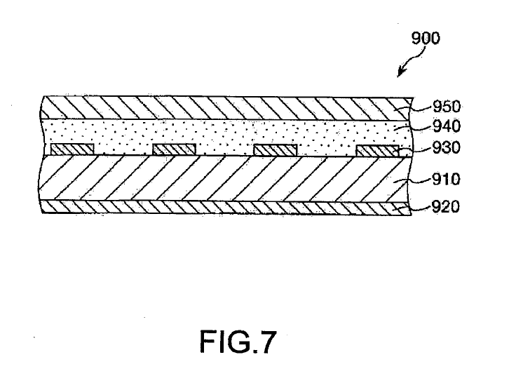

Next, an electronic apparatus according to another embodiment of the invention which includes the electro-optical device 10 will be described with reference to FIG. 6.

FIG. 6 is a perspective view showing the configuration of a mobile phone (PHS is also included) to which the electronic apparatus according to the embodiment of the invention is applied.

In FIG. 6, a mobile phone 1200 includes a plurality of operation buttons 1202, an earpiece 1204, a mouthpiece 1206, the electro-optical device 10, and a backlight (not shown).

In addition, examples of the electronic apparatus according to the embodiment of the invention include not only the mobile phone shown in FIG. 6 but also a personal computer (mobile personal computer), a digital still camera, a projection type display device, a television, a video camera, a view finder type or monitor direct view type video tape recorder, a car navigation system, a pager, an electronic diary (electronic diary with a communication function is also included), an electronic dictionary, an electronic calculator, an electronic game machine, a word processor, a workstation, a video phone, a television monitor for security, electronic binoculars, a POS terminal, an apparatus having a touch panel (for example, a cash dispenser in a financial institution or an automatic ticket vending machine), medical equipment (for example, an electronic thermometer, a sphygmomanometer, a blood sugar meter, an electrocardiographic display device, ultrasonic diagnostic equipment, a display device for endoscope), a fish detector, various kinds of measuring equipment, instruments (for example, instruments for vehicles, aircraft, and ships), and a flight simulator. In addition, it is needless to say that the above-described touch panel device according to the embodiment of the invention may be applied as display units or monitor units of the various electronic apparatuses.

While the touch panel device, the electro-optical device, and the electronic apparatus according to the embodiments of the invention have been described on the basis of the embodiments shown in the drawings, the invention is not limited thereto. For example, in the touch panel device, the electro-optical device, and the electronic apparatus according to the embodiments of the invention, the configuration of each section may be replaced by an arbitrary configuration with the same function, and an arbitrary configuration may be added.

The entire disclosure of Japanese Patent Application No. 2009-058784, filed Mar. 11, 2009 is expressly incorporated by reference herein.

What is claimed is:

1. A touch panel device comprising:
a touch panel substrate;
a plurality of surface-shaped electrodes which are provided on one surface side of the touch panel substrate and are separated from each other;
a first wiring line which makes a connection between the surface-shaped electrodes adjacent to each other in a first direction of the touch panel substrate;
a second wiring line which makes a connection between the surface-shaped electrodes adjacent to each other in a second direction different from the first direction and which is formed integrally with the surface-shaped electrodes; and
an insulating layer which insulates the first and second wiring lines from each other and is formed by a liquid-phase deposition method,
wherein the first wiring line, the insulating layer, and the second wiring line are disposed on the one surface of the touch panel substrate so as to overlap each other in this order.

2. The touch panel device according to claim 1,
wherein the thickness of an edge portion of the insulating layer decreases gradually toward an outer edge.

3. The touch panel device according to claim 1,
wherein the first wiring line is formed by the liquid-phase deposition method.

4. The touch panel device according to claim 3,
wherein the thickness of an edge portion of the first wiring line decreases gradually toward an outer edge.

5. The touch panel device according to claim 1,
wherein at least one of the insulating layer and the first wiring line is formed by an ink jet method.

6. The touch panel device according to claim 1,
wherein the plurality of surface-shaped electrodes and the second wiring line are formed by a gas-phase deposition method.

7. The touch panel device according to claim 1,
wherein at least middle portions of the plurality of surface-shaped electrodes are located on the same plane.

8. The touch panel device according to claim 1,
wherein the average thickness of the insulating layer is 0.5 to 3 μm.

9. An electro-optical device comprising:
an electro-optical element; and
the touch panel device according to claim 1 which is disposed on one surface side of the electro-optical element.

10. An electronic apparatus comprising the electro-optical device according to claim 9.
